(19) United States
(12) Patent Application Publication
(10) Pub. No.: US 2015/0120335 A1
(43) Pub. Date: Apr. 30, 2015

(54) METHOD AND SYSTEM FOR GENERATING A QUOTE

(71) Applicants: Benjamin Braun, London (GB); Hardik Shah, Hounslow (GB)

(72) Inventors: Benjamin Braun, London (GB); Hardik Shah, Hounslow (GB)

(73) Assignee: BGL GROUP LIMITED, Peterborough (GB)

(21) Appl. No.: 14/179,604

(22) Filed: Feb. 13, 2014

(30) Foreign Application Priority Data
Oct. 30, 2013 (GB) 1319200.0

(51) Int. Cl. G06Q 30/06; G06Q 30/02; G06Q 50/06

(52) U.S. Cl. CPC G06Q 30/0611; G06Q 50/06; G06Q 40/08; G06Q 30/0283
USPC 705/4; 705/26.4

(57) ABSTRACT

There is provided a method for generating a quote of a first service provider, the quote being personalised to a particular customer. The method comprises:
capturing (110, 120) from the particular customer a document (10) from a second service provider that is directed towards the particular customer;
extracting information (130) on the particular customer from the document;
generating (140, 150) the quote based upon the extracted information; and
electronically communicating (160) the quote to the particular customer.

The present invention relates to a method and system of generating a quote, in particular a quote for services of a service provider. A quote typically comprises an offer from a service provider to provide specified service(s) at specified price(s).

When seeking new services, or replacement and/or renewal of existing services, it is common for customers to gather various quotes from different service providers for the desired services. A quote is typically a function of the customer's requirements for the service, and so generally a customer must provide their requirements to the service provider in order for the service provider to prepare the customer a quote.

Service comparison providers are also known in the art, and these typically enable simultaneous preparation of various quotes from different service providers based upon responses gathered from a customer. The customer enters their requirements into a website of the service comparison provider, and then a search is conducted against various service provider databases, to which the service comparison provider has access. A long list of quotes matching the customer's requirements, including service provider details, tariff/policy information and prices, is then produced. The quotes may be ordered according to various criteria, such as “price” or “contract length”. Customers are then free to select and purchase one of the quotes by being directed to the service provider's website, or in some instances, have the opportunity to purchase by phone or within the website of the service comparison provider. As an alternative, some quotes may be saved for a certain period of time, and retrieved at a later date to progress them further.

These service comparison providers greatly ease the customer's gathering of quotes, since the customer only needs to register their requirements with the service comparison provider, rather than with each of the service providers individually.

However, the customer still needs to manually enter their requirements for the service at least once, and customers may become confused by all of the various questions which they are asked, and may be unaware of the relative importance of the questions.

The responsibility for inputting the correct information lies with the customer, and some customers worry about inputting data incorrectly, about misunderstanding what the questions are asking, or about what consequences may ensue if questions are answered incorrectly.

Customers can also find the prospect of responding to multiple questions time-consuming and/or off-putting, which can dissuade them from even checking what service providers competing with their current service provider may have to offer.

There is therefore a need for a system which can help enable customers to obtain quotes from service providers with a reduced need to manually respond to questions on their requirements.

According to a first aspect of the invention, there is provided a method for generating a quote of a first service provider, the quote being personalised to a particular customer. The method comprises:
capturing from the particular customer a document from a second service provider that is directed towards the particular customer;
extracting information on the particular customer from the document;
generating the quote based upon the extracted information; and
electronically communicating the quote to the particular customer.

Therefore, instead of requiring a customer to respond to multiple questions in order to establish their requirements, the customer can instead provide a document from their existing service provider, and the document can be used to determine what services alternate service providers may be able to provide to the customer. The use of a document from an existing service provider of the customer provides a much more convenient technical solution for gathering relevant information from the customer, than the known solution of asking the customer to manually respond to multiple questions. Furthermore, the burden of responsibility on the customer for inputting the user information is substantially reduced and the potential for mistakes (caused by customer error) is also reduced by ensuring that the customer's existing service provider document, for example utility bill or insurance policy, is correctly reviewed. This can help in presenting customers with more appropriate quotes that better suit their circumstances, and to help reassure customers that they are being presented with appropriate quotes. Preferably, the first service provider provides the same or similar services to the second (existing) service provider, so that the document contains information that is relevant to the first service provider.

Advantageously, the capturing of the document may be performed by a first electronic device of the particular customer, for example a Smartphone or a Tablet device. The capturing may comprise identifying an electronic document stored in the first electronic device, so that the document or information extracted from the document can be sent to a second electronic device for generating the quote. If the document is not already in electronic form, then the capturing may further comprise photographing a physical document using a camera of the first electronic device to provide the document in electronic form. The second electronic device may be a device of the first service provider, or may be a device that is configured to interrogate a device of the first service provider, to enable the quote to be generated.

Once the quote has been generated, the second electronic device may send a push notification to the first electronic device to notify the particular customer that the quote is ready for retrieval from the second electronic device.

The extraction of the information from the document may be performed by the first electronic device and the information sent to the second electronic device, or the document itself may be sent from the first electronic device to the second electronic device. If the document is sent to the second electronic device, then the second electronic device may extract the information, for example using Optical Character Recognition (OCR), or if the second electronic device does not recognise the type of the document or does not have the capability to extract the information, then the second electronic device may request a human operator to extract the information from the document and input the information into the second electronic device.

The extracted information may for example comprise postal address information, date of birth information, and/or occupation information of the particular customer. The document may for example be a utility bill or an insurance renewal quote that is directed towards the particular customer, and the extracted information may include information such as energy usage levels or time periods covered by the utility bill/insurance renewal quote.

Advantageously, the method may further comprise generating further quotes from further service providers, the further quotes also being generated based upon the extracted information. Then, the quote and the further quotes can be electronically communicated to the particular customer so that the particular customer can compare them, for example on a display of the first electronic device. The generation of the quotes may comprise querying databases maintained by the first and further service providers, according to the information on the particular customer that has been extracted from the document.

According to a second aspect of the invention, there is provided an electronic device for providing a quote of a first service provider, the quote being personalised to a particular customer. The electronic device comprises a processor configured to:
capture a document from a second service provider that is directed towards the particular customer;
send, to a second electronic device associated with the first service provider, at least one of the document and information on the particular customer extracted from the document;
retrieve a quote from the second electronic device, the quote being generated by the second electronic device based upon information on the particular customer extracted from the document; and
provide the quote to the particular customer.

The electronic device may further comprise a camera, and the processor may be configured to capture the document by photographing the document with the camera. The electronic device may for example be a Smartphone or a Tablet.

The processor may be further configured to retrieve, from the second electronic device, further quotes from further service providers associated with the second electronic device, the further quotes being generated by the second electronic device based upon the information on the particular customer extracted from the document; and provide the further quotes to the particular customer. The quote and further quotes may for example be displayed on a display screen of the electronic device. Then, the particular customer may compare the first and further quotes to the pricing and level of service from their existing service provider to help determine whether changing service providers may be desirable, and compare the first and further quotes to one another to help determine which alternate service provider to choose. If and when the particular customer wishes to investigate one of the quotes further, the particular customer may be able to select the desired quote using the electronic device, and in response the electronic device may display further information on the selected quote and/or allow purchase of the selected quote, for example by re-directing a web browser of the electronic device to a web page that is maintained by the service provider that offers the selected quote.

According to a third aspect of the invention, there is provided an electronic device for generating a quote of a first service provider, the quote being personalised to a particular customer, based upon information on the particular customer that is extracted from a document, the document being from a second service provider and being directed towards the particular customer. The electronic device comprises a processor that is configured to:
receive at least one of the document and information on the particular customer extracted from the document;
generate the quote based upon information on the particular customer extracted from the document; and
send the quote to a first electronic device of the particular customer.

Advantageously, the processor may be further configured to generate further quotes personalised to the particular customer based upon the information on the particular customer extracted from the document, the further quotes being of further service providers; and to provide the further quotes to the particular customer. The processor may be configured to generate the quote and the further quotes by querying databases maintained by the first and further service providers according to the information on the particular customer extracted from the document.

According to a fourth aspect of the invention, there is provided a system comprising the electronic device of the second aspect and the electronic device of the third aspect, wherein the electronic devices are configured to interoperate with one another to generate and provide quotes to the particular customer.

Embodiments of the invention will now be described by way of example only and with reference to the accompanying drawings, in which:

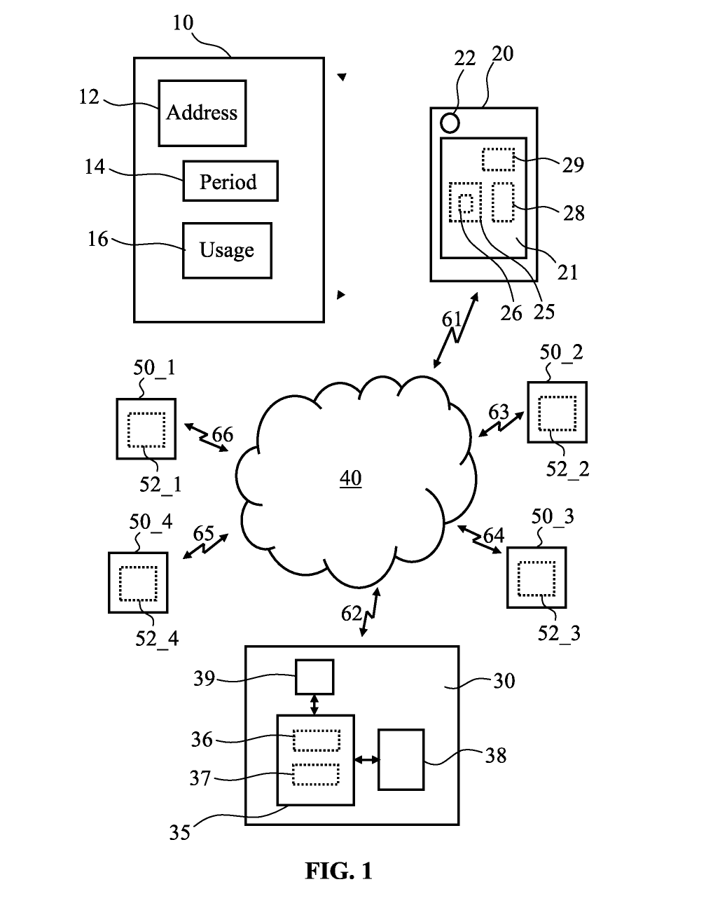

FIG. 1 shows a schematic diagram of a system according to a first embodiment of the invention;

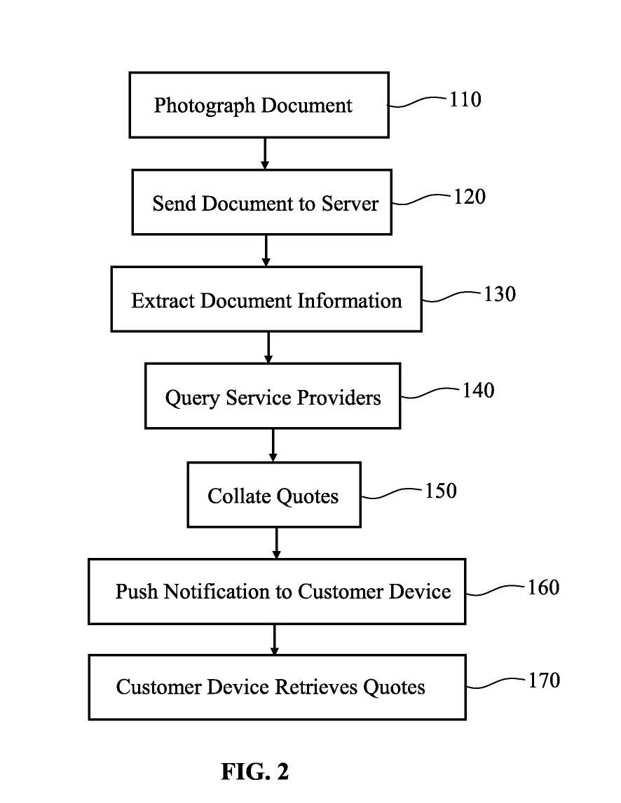

FIG. 2 shows a flow diagram of a method according to the first embodiment;

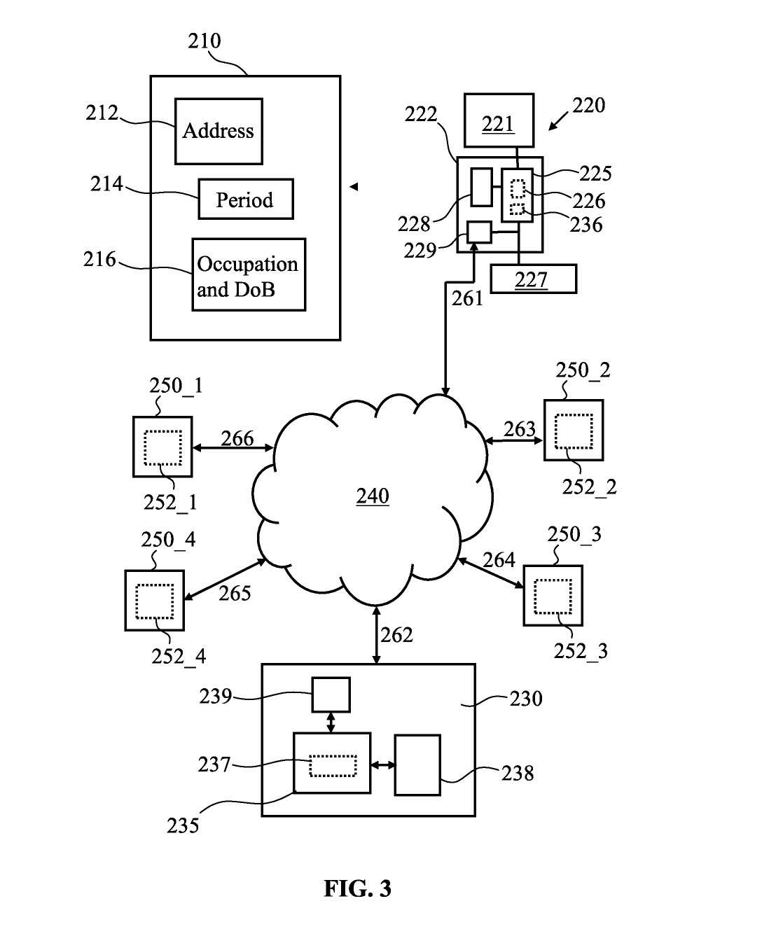

FIG. 3 shows a schematic diagram of a system according to a second embodiment of the invention; and

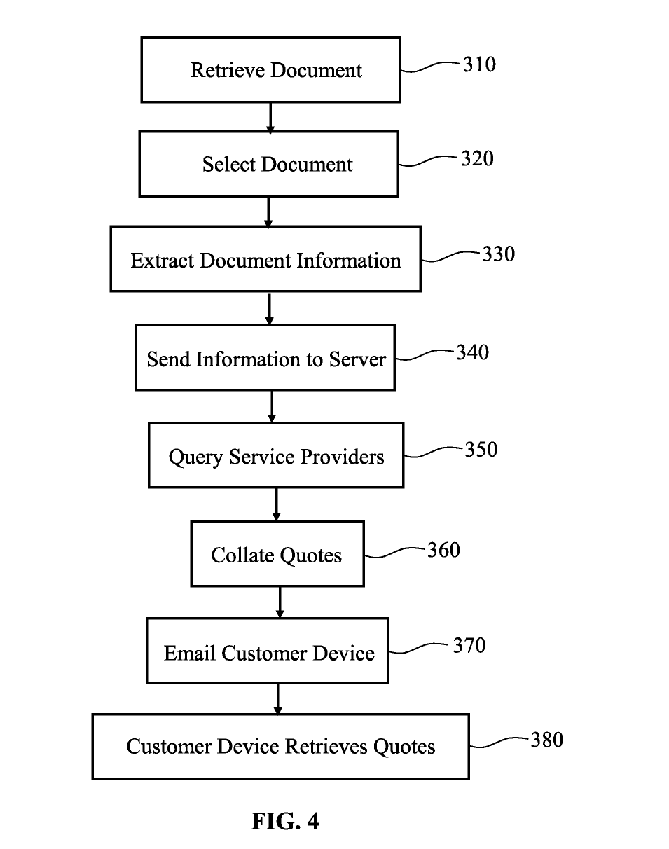

FIG. 4 shows a flow diagram of a method according to the first embodiment.

A first embodiment of the invention will now be described with reference to FIGS. 1 and 2. FIG. 1 shows a schematic diagram of a system comprising a first electronic device in the form of a smartphone 20, and a second electronic device in the form of a computer server 30.

The smartphone 20 comprises a camera 20 and a touch sensitive display screen 21. Beneath the display screen 21, the smartphone comprises a processor 25, a memory 28, and a radio module 29. The processor has been configured to operate according to an application software (app) 26.

The computer server 30 comprises a processor 35, a memory 38, and a radio module 39. The processor has been configured to operate according to an extraction software module 36, and a quote generation software module 37.

In this embodiment there are four service providers in the form of energy providers that sell gas and/or electricity for use by consumers. Each energy provider has a respective computer, 50_1, 50_2, 50_3, and 50_4. Each computer maintains a respective database, 52_1, 52_2, 52_3, and 52_4 of the energy supply services and prices that the corresponding energy provider offers.

The energy provider computers 50_1-50_4, the server computer 30, and the smartphone 20 are all connected to the Internet 40. The energy provider computers, the server computer 30, and the smartphone 20 are all shown as having wireless connections 61-66 to the Internet, although wired connection(s) would obviously also be possible, and may be preferred if the connection(s) were required to carry a large amounts of data. The server computer 30 is considered to be associated with the energy providers of the energy provider computers 50_1-50_4, since the server computer 30 is configured to access the respective databases 52_1-52_4 of the energy provider computers.

An energy bill 10 in the form of a physical document is also shown in FIG. 1. The energy bill 10 relates to gas and/or electricity that has been provided by an energy provider to the customer who owns the smartphone 20. The energy bill 10 has a section 12 giving the postal address of the customer, a section 14 stating the period of time to which the energy bill relates, and a section 16 stating how much gas and/or electricity has been supplied to the customer during the time period. The energy bill 10 may be from one of the energy providers corresponding to one of the energy provider computers 50_1-50_4, or it may be from a different energy provider. Clearly, in alternative embodiments the energy providers may be alternate types of service providers, for example water, Internet, television, or financial service providers.

Now referring to FIG. 2, in a first step 110 the customer receives the energy bill 10, for example through the post, and takes a photograph of the energy bill 10 using the camera 22 of their smartphone 20. The photograph is stored in the memory 28, and constitutes an electronic document corresponding to the energy bill 10. Clearly, if the energy bill 10 comprises more than one page, then the photograph may comprise individual photographs of each page.

Next in step 120, the application software 26 is directed by the customer via touchscreen display 21, to cause the processor 25 to access the memory 28 and to send the photograph to the computer server 30. Specifically, the processor 25 retrieves the photograph from the memory 28, and sends it to the computer server 30 via the radio module 29, the wireless connection 61, the Internet 40, the wireless connection 62, and the radio module 39.

The photograph is received at the computer server 30, and in a step 130 the processor 35 acts according to the extraction software module 36 to extract the postal address 12, the time period 14, and the energy usage 16. Specifically, the extraction software module 36 performs optical character recognition to determine the content of text appearing in the photograph.

The photograph may be sent by the application software 26 along with an indication that the photograph shows an energy bill, so that the extraction software module 36 is aware of the types of information that it should search for. Alternatively, the extraction software module 36 may simply rely on the information that it extracts to determine what type of document the photograph shows, and therefore what information should be extracted. For example if the photograph includes the name of a known energy supplier, then the extraction software module 36 may recognise this name as belonging to an energy supplier, and so aim to extract information relevant to energy supplies, such as energy usage levels. If the extraction software module 36 cannot extract sufficient information from the photograph, then it creates a prompt for a human user to review the document and enter the information manually.

Once the address 12, time period 14, and usage level 16 information has been extracted, the information is passed to the quote generation software module 37 for generation of quotes. In a step 140, the processor 35 under control of the quote generation software module 37 queries the four databases 52_1-52_4 of the four energy provider computers 50_1-50-4 to determine whether they are able to provide energy to the address 12, and if so, then to retrieve information on service tariffs offered by the energy suppliers that provide the rate of energy usage indicated by the time period 14 and energy usage 16. Cleary, if the time period 14 corresponds to a winter time period, then the energy usage level 16 may be higher be higher than the yearly average energy usage rate of the customer, since energy usage is typically higher in winter than in other seasons, and this can be taken into account when querying the databases. Based on the retrieved information, the processor 35 under control of the quote generation software module 37 generates quotes for each of the four energy providers.

In a step 150, the processor 35 collates the quotes together so that they can be compared to one another, and in a step 160 sends a Push Notification to the smartphone 20 via the Internet 40 to notify the customer that the quotes are ready for viewing.

In a step 170, the customer receives the Push Notification, and retrieves the collated quotes to their smartphone 20 via the radio module 39, wireless connection 62, Internet 40, and wireless connection 61. The processor 25 receives the quotes and the application software 26 displays the quotes on the display screen 21. The customer may select one of the quotes using the touchscreen display 21, and be re-directed to the corresponding energy provider computer for agreeing an energy service contract based upon the selected quote.

A second embodiment of the invention will now be described with reference to FIGS. 3 and 4. FIG. 3 shows a schematic diagram of a system comprising a first electronic device in the form of a desktop computer 220, which is owned by a customer, and a second electronic device in the form of a computer server 230, which is owned by a service comparison provider.

The desktop computer 220 comprises a display screen 221, a base unit 222, and a keyboard 227. The base unit 222 has a processor 225, and a memory 228 and network interface 229 connected to the processor 225. The processor 225 has been configured to operate according to a document selector software module 226, and an extraction software module 236. The document selector software module 226, and the extraction software module 236 are typically downloaded to the desktop computer 220 from the service comparison provider having the computer server 230, and may be provided together within a single application.

The computer server 230 comprises a processor 235, a memory 238, and a network interface 239. The processor has been configured to operate according to a quote generation software module 237.

In this embodiment there are four service providers in the form of insurance providers that sell car insurance to consumers. Each insurance provider has a respective computer, 250_1, 250_2, 250_3, and 250_4. Each computer maintains a respective database, 252_1, 252_2, 252_3, and 252_4 of the insurance products that the corresponding insurance provider offers.

The insurance provider computers 250_1-250_4, the server computer 230, and the desktop computer 220 are all connected to the Internet 240 via wired connections 261-266.

An insurance renewal quote 210 in the form of an electronic document stored within the memory 228 of the desktop computer 220 is also shown in FIG. 3. The insurance renewal quote 210 is a car insurance quote for the customer owning the desktop computer 230. The insurance renewal quote 210 was emailed to the customer by the customer's current insurer, and was downloaded by the customer into the memory 228 of the desktop computer 220.

The insurance renewal quote 210 has a section 212 giving the postal address of the customer, a section 214 stating the period of time that the insurance would cover, and a section 216 stating various details relevant to the car insurance quote, such as the name, occupation, and date of birth (DoB) of the customer, and vehicle registration number. The customer's current insurer which provided the insurance renewal quote 210 may be one of the insurance providers corresponding to one of the computers 250_1-250_4, or a different insurance provider.

Now referring to FIG. 4, in a first step 310 the customer receives the insurance renewal quote 210 in their email inbox, and downloads the insurance renewal quote to the desktop computer 220. Next, in step 320, the customer uses the document selector software module 226 to select the insurance renewal quote 210, and the document selector software module 226 passes the insurance renewal quote 210 to the extraction software module 236.

In step 330, the processor 225 acts according to the extraction software module 236 to extract the postal address 212, the time period 214, and the name, occupation, date of birth (DoB), and vehicle registration number information 216. Specifically, the extraction software module 236 searches for text in the document that matches the expected format of the required information. The extraction software module 236 may prompt the user for any required information that it cannot discern from the insurance renewal quote 210.

At step 340, the extraction software module 236 sends the extracted information to the computer server 230, via the network interface 229, wired connection 261, Internet 240, wired connection 262, and network interface 239. In a step 350, the processor 235 under control of the quote generation software module 237 queries the four databases 252_1-252_4 of the four insurance provider computers 250_1-250-4 via the Internet 240 to retrieve information on car insurance products appropriate to the address, occupation, date of birth (DoB), and vehicle registration number information within the extracted information. Based on the retrieved information, the processor 235 under control of the quote generation software module 237 assembles quotes for each of the four insurance providers, the quotes for the same time period 214 as the insurance renewal quote.

In a step 360, the processor 235 collates the quotes together so that they can be compared to one another, and in a step 370 sends an email to the customer to inform the customer that their quote is ready for viewing. In a step 380, the customer receives the email, and retrieves the collated quotes to their desktop computer 220 for display on the display 221. The customer may select one of the quotes using the keyboard 227 (and/or computer mouse if present), and be re-directed to the corresponding insurance provider computer to buy insurance based on the selected quote.

In the second embodiment, the databases 252_1-252_4 are accessed by the computer server 230 via the Internet 240, although in alternative embodiments local copies of the databases 252_1-252_4 could be stored at the computer server 230 so that they are more easily accessible.

Furthermore, the quote generation software module 237 could be moved to the processor 225, in addition to the extraction software module 237, and the computer server 230 simply used as a portal for querying the databases 252_1-252_4.

Further embodiments falling within the scope of the appended claims will also be apparent to the skilled person.

1. A method for generating a quote of a first service provider, the quote being personalised to a particular customer, the method comprising:
capturing from the particular customer a document from a second service provider that is directed towards the particular customer;
extracting information on the particular customer from the document;
generating the quote based upon the extracted information; and
electronically communicating the quote to the particular customer.

2. The method of claim 1, wherein the capturing is performed by a first electronic device of the particular customer.

3. The method of claim 2, wherein the capturing comprises photographing a physical document by the first electronic device.

4. The method of claim 2, wherein the capturing comprises identifying an electronic document stored in the first electronic device.

5. The method of claim 2, wherein the generating is performed by a second electronic device associated with the first service provider.

6. The method of claim 5, further comprising the first electronic device sending the captured document to the second electronic device.

7. The method of claim 6, wherein the extracting is performed by the second electronic device.

8. The method of claim 5, further comprising the second electronic device sending a push notification to the first electronic device once the quote has been generated.

9. The method of claim 2, wherein the electronically communicating comprises retrieving the quote to the first electronic device for viewing of the quote by the particular customer.

10. The method of claim 1, wherein the extracted information comprises postal address information of the particular customer.

11. The method of claim 1, wherein the extracted information comprises date of birth information of the particular customer.

12. The method of claim 1, wherein the extracted information comprises occupation information of the particular customer.

13. The method of claim 1, wherein the document is a utility bill that is directed towards the particular customer.

14. The method of claim 13, wherein the utility bill is a gas or electricity bill directed towards the particular customer.

15. The method of claim 13, wherein the extracted information comprises a usage level of the utility by the particular customer;

16. The method of claim 15, wherein the usage level is a number of KWh's of energy consumed by the particular customer.

17. The method of claim 13, wherein the extracted information comprises a time period covered by the utility bill.

18. The method of claim 1, wherein the document is an insurance renewal quote that is directed towards the particular customer.

19. The method of claim 18, wherein the extracted information comprises a time period covered by the insurance renewal quote.

20. The method of claim 1, wherein the generating further comprises generating further quotes from further service providers, the further quotes being generated based upon the extracted information; and wherein the electronically communicating further comprises electronically communicating the further quotes to the particular customer.

21. The method of claim 20, wherein the generating the quote and the further quotes comprises querying databases maintained by the first and further service providers according to the information on the particular customer extracted from the document.

22. The method of claim 21, further comprising displaying the quote and the further quotes to the particular customer on a display so that the quotes can be compared by the particular customer.

23. An electronic device for providing a quote of a first service provider, the quote being personalised to a particular customer, the electronic device comprising a processor configured to:
capture a document from a second service provider that is directed towards the particular customer;
send, to a second electronic device associated with the first service provider, at least one of the document and information on the particular customer extracted from the document;
retrieve a quote from the second electronic device, the quote being generated by the second electronic device based upon information on the particular customer extracted from the document; and
provide the quote to the particular customer.

24. The electronic device of claim 23, wherein the document is a physical document, wherein the electronic device further comprises a camera, and wherein the processor is configured to capture the physical document by photographing the physical document with the camera.

25. The electronic device of claim 23, wherein the electronic device is a smartphone, tablet, or desktop computer.

26. The electronic device of claim 23, wherein the processor is further configured to:
retrieve, from the second electronic device, further quotes from further service providers associated with the second electronic device, the further quotes being generated by the second electronic device based upon the information on the particular customer extracted from the document; and
provide the further quotes to the particular customer.

27. The electronic device of claim 26, wherein the electronic device further comprises a display, and wherein the processor is configured to provide the quote and the further quotes to the particular customer by displaying the quotes on the display so that the quotes can be compared by the particular customer.

28. An electronic device for generating a quote of a first service provider, the quote being personalised to a particular customer, based upon information on the particular customer that is extracted from a document, the document being from a second service provider and being directed towards the particular customer, wherein the electronic device comprises a processor configured to:
receive at least one of the document and information on the particular customer extracted from the document;
generate the quote based upon information on the particular customer extracted from the document; and
send the quote to a first electronic device of the particular customer.

29. The electronic device of claim 28, wherein the processor is further configured to:
generate further quotes personalised to the particular customer based upon the information on the particular customer extracted from the document, the further quotes being of further service providers; and
provide the further quotes to the particular customer.

30. The electronic device of claim 29, wherein the processor is configured to generate the quote and the further quotes by querying databases maintained by the first and further service providers according to the information on the particular customer extracted from the document.

31. A system comprising the electronic device of claim 23, wherein the electronic device is configured to interoperate with another device to generate and provide quotes to the particular customer.

32. A system comprising the electronic device of claim 28, wherein the electronic device is configured to interoperate with another device to generate and provide quotes to the particular customer.
